(19) United States
(12) Patent Application Publication
(10) Pub. No.: US 2019/0036465 A1
(43) Pub. Date: Jan. 31, 2019

(54) SYSTEM AND METHOD FOR STARTING AN ELECTRIC MOTOR

(71) Applicant: Nidec Motor Corporation, St. Louis, MO (US)

(72) Inventors: Christopher D. Schock, O'Fallon, MO (US); Prakash B. Shahi, St. Louis, MO (US); Hector M. Hernandez, Godfrey, IL (US); Bret S. Clark, Oakville, MO (US)

(73) Assignee: Nidec Motor Corporation, St. Louis, MO (US)

(21) Appl. No.: 16/151,008

(22) Filed: Oct. 3, 2018

Related U.S. Application Data
(63) Continuation of application No. 14/295,057, filed on Jun. 3, 2014, now abandoned.

(51) Int. Cl. H02P 6/20; H02P 3/18; H02P 1/46; H02P 1/26

(52) U.S. Cl. CPC H02P 6/20; H02P 3/18; H02P 1/26; H02P 1/46

(57) ABSTRACT

A system and method for starting electric motors. A controller attempts to start a motor without applying a brake to the rotor. If the motor fails to start, the controller applies a strength of braking and then again attempts to start the motor. If the motor still fails to start, the controller iteratively increases the strength of braking and attempts to start the motor until a maximum strength of braking and/or a maximum number of attempts to start the motor is reached. Alternatively, a sensing system first determines whether the rotor is rotating. If the rotor is rotating, the sensing system determines the speed of rotation, the controller determines a strength of braking that will halt the rotation based on the speed of rotation, applies that strength of braking to halt the rotation of the rotor, and then attempts to start the motor.

### RELATED APPLICATIONS

The present U.S. non-provisional patent application is a continuation and claims priority benefit of a prior-filed U.S. non-provisional patent application with the same title, Ser. No. 14/295,057, filed Jun. 3, 2014. The entire content of the identified prior-filed application is incorporated by reference into the present application as if set forth in its entirety herein.

### FIELD

The present invention relates to systems and methods for starting electric motors.

### BACKGROUND

Electric motors commonly include a stationary “stator” and a rotating “rotor”. The rotor rotates within (or around) the stator when the motor is energized with a driving waveform. When the driving waveform is removed from the motor, the rotor may coast to a stop over time due to the inertia of the rotor and anything that may be coupled to it.

The rotation may be stopped more quickly using a braking method. One braking method involves using brake pads, pulleys, or other such mechanisms to induce friction that reduces the rotor's rotational speed. Another braking method involves adjusting the frequency of the driving waveform to be less than the rotor frequency, such that the rotating magnetic field created by the stator induces rotational pressure on the rotor to reduce its rotational speed. Another braking method involves applying a direct current (DC) voltage to the stator windings which creates a stationary magnetic field that applies a static torque to the rotor to reduce its rotational speed. Furthermore, the existence of rotation can be determined using a sensing method. One sensing method involves coupling a sensor, such as a Hall effect sensor, to the motor's shaft to detect its rotation. Another sensing method uses various algorithms to estimate when the rotor stops rotating based on measured electrical parameters.

The open-loop-controlled Volts per Hertz starting routine developed for electric motors used in, e.g., heating and air conditioning variable speed (HAC VS) applications, involves maintaining a particular ratio of the amplitude of the motor phase voltage (expressed in Volts) to the synchronous electrical frequency (expressed in Hertz) applied to a motor, in which the particular ratio is defined by the base point of the motor. The open-loop controller provides input based on the current state of the actual system and the expected state of a model system, rather than on feedback. This starting routine can be tuned to start when the motor is rotating before being energized, though it would then fail to start when the motor is not rotating before being energized. However, with some newer motor designs that have a higher winding resistance and high back-emf, the starting routine has limitations starting when the motor is rotating before being energized. The starting routine can be tuned to start motors based on their winding designs, but doing so requires two tuned sets: A first set for starting when the motor is not rotating and a second set for starting when the motor is rotating.

This background discussion is intended to provide information related to the present invention which is not necessarily prior art.

### SUMMARY

Embodiments of the present invention solve the above-described and other problems and limitations by providing a system and method operable to reliably start electric motors without regard to their winding designs and without regard to whether their unenergized rotors are rotating or not. In particular, the present invention provides an improvement to the open loop volts per hertz original starting routine used in, e.g., HAC VS commercial motors.

In a first implementation of a first embodiment, the system may broadly comprise a controller in communication with the electric motor and operable to control operation of the motor, and a braking system operable to reduce a rotation of the rotor, wherein the controller first attempts to start the electric motor without applying the braking system to the rotor. If the electric motor fails to start, the controller causes the braking system to apply an initial strength of braking, and then again attempts to start the electric motor. If the motor still fails to start, the controller iteratively causes the braking system to increase the strength of braking and attempts to start the electric motor until a predetermined maximum strength of braking is reached.

In a second implementation of the first embodiment, the system may broadly comprise the controller and the braking system, wherein the controller first attempts to start the electric motor without applying the braking system to the rotor. If the electric motor fails to start, the controller causes the braking system to apply an initial strength of braking to the rotor, and then again attempts to start the electric motor. If the electric motor still fails to start, the controller iteratively causes the braking system to increase the strength of braking applied to the rotor and attempts to start the electric motor until a predetermined maximum number of attempts to start the electric motor is reached.

In a third implementation of the first embodiment, the system may broadly comprise the controller and the braking system, wherein the controller first attempts to start the electric motor without applying the braking system to the rotor. If the electric motor fails to start, the controller causes the braking system to apply an initial strength of braking to the rotor, and then again attempts to start the electric motor. If the motor still fails to start, the controller iteratively causes the braking system to increase the strength of braking applied to the rotor and attempts to start the electric motor until a predetermined maximum strength of braking is reached. If the motor still fails to start, the controller iteratively causes the braking system to maintain the predetermined maximum strength of braking applied to the rotor and again attempts to start the electric motor until a predetermined maximum number of attempts to start the electric motor is reached.

Any or all of these implementations may further include any one or more of the following additional features. The electric motor may be a variable speed electric induction or permanent magnet motor. The braking system may employ an opposing driving waveform to reduce the rotation of the rotor, or the braking system may employ an opposing magnetic field to reduce the rotation of the rotor. The initial strength of braking may be approximately between 1% and 3%, and the strength of braking may be increased by approximately between 1% and 3% for each iteration. The predetermined maximum strength of braking may be approximately between 6% and 10%. The predetermined maximum number of attempts to start the electric motor may be between 8 and 12.

In an implementation of a second embodiment, the system may broadly comprise the controller, a sensing system operable to sense the rotation of the rotor, and the braking system, wherein the sensing system first determines whether the rotor is rotating. If the rotor is rotating, the sensing system determines the speed of rotation, the controller determines a strength of braking that will halt the rotation based on the speed of rotation, the controller causes the braking system to apply the strength of braking to halt the rotation of the rotor, and the controller attempts to start the electric motor.

This implementation may further include any one or more of the following additional features. The electric motor may be a variable speed electric induction or permanent magnet motor. The sensing system may determine whether the rotor is rotating by sensing an electric current flowing through a power inverter coupled with the electric motor.

Additionally, each of these systems may be alternatively characterized as methods based on their functionalities.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a block diagram of a motor system constructed in accordance with an embodiment of the invention;

FIG. 2 is an exploded isometric view of a stator component and a rotor component of the motor system shown in FIG. 1;

FIG. 3 is a flow diagram of steps in a first implementation of a first embodiment of a method of the present invention;

FIG. 4 is a flow diagram of steps in a second implementation of the first embodiment of the method of the present invention;

FIG. 5 is a flow diagram of steps in a third implementation of the first embodiment of the method of the present invention;

FIG. 6 is a schematic diagram of a power inverter component of the motor system of FIG. 1; and

FIG. 7 is a flow diagram of steps in an implementation of a second embodiment of the method of the present invention.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

Referring to FIG. 1, an electric motor system 10 constructed in accordance with a first embodiment of the present invention is shown. The motor system 10 may broadly include an electric motor 12, a power source 14, and a motor control system 16 operable to control operation of the motor 12, with the motor control system 16 including a controller 18 and a braking system 20 operable to halt rotation of the motor 12. The motor system 10 may drive a load. For example, the motor system 10 may be a fan or a pump which may be part of a heating and air-conditioning unit or an appliance, such as a washing machine or a clothes dryer, which may include additional electrical or mechanical components not described herein.

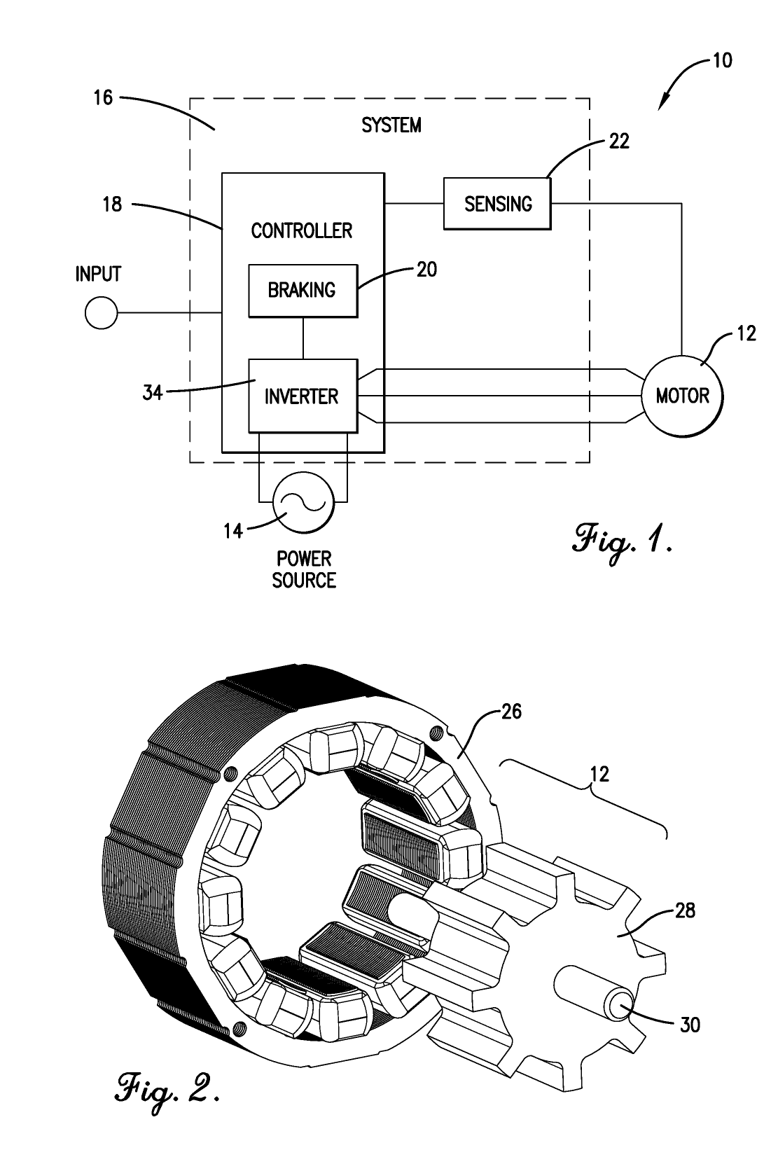

The motor 12 may be an electric induction or permanent magnet motor. For example, the motor 12 may be a three-phase, four-pole alternating current (AC) induction or permanent magnet motor rated to operate at a maximum voltage of approximately between 190 Volts and 200 Volts and a maximum current of approximately between 4 Amps and 6 Amps. Referring also to FIG. 2, the motor may include a stationary stator 26, a rotatable rotor 28, and a shaft 30 which couples the rotor 28 with the load. The power source 14 may be a conventional AC power source, such as a standard 115 Volt or 230 Volt source available in residential and commercial buildings via standard electrical outlets.

The motor control system 16 may be broadly operable to control operation of the motor 12, including receiving power from the power source 14 and generating a driving waveform to power the motor 12. To that end, the motor control system 16 may include a controller 18 operable to receive input power from the power source 14, create the driving waveform, and communicate the driving waveform to the motor 12. The controller 18 may include digital logic components, programmable logic devices, or general purpose computer processors such as microcontrollers or microprocessors. For example, the controller 18 may include a computer processor operable to execute a computer program to manage certain aspects of the operation of the motor 12. The computer program may include a series of executable instructions for implementing logic functions in the controller 18. The motor system 10 may further include a memory (not shown) that is accessible to the controller 18 and operable to store the computer program. The memory may be of any suitable type.

Referring also to FIG. 6, the controller 18 may further include a DC-to-AC power inverter 34 operable to convert DC power to AC power at a required frequency and amplitude to power the motor 12. The power inverter 34 may include three half-bridge rectifiers, with each rectifier including two transistors that are alternately turned on and off to produce three voltage signals, each 120 degrees apart in phase, to power the three-phase motor 12. The braking system 20 may be of any type operable to reduce the rotational speed of the rotor 28. For example, the braking system 20 may employ an opposing driving waveform or an opposing magnetic field in which the braking system 20 pulses voltage to the motor 12 by turning on and off the power inverter 34, wherein the pulse time corresponds to the strength of braking at the motor 12.

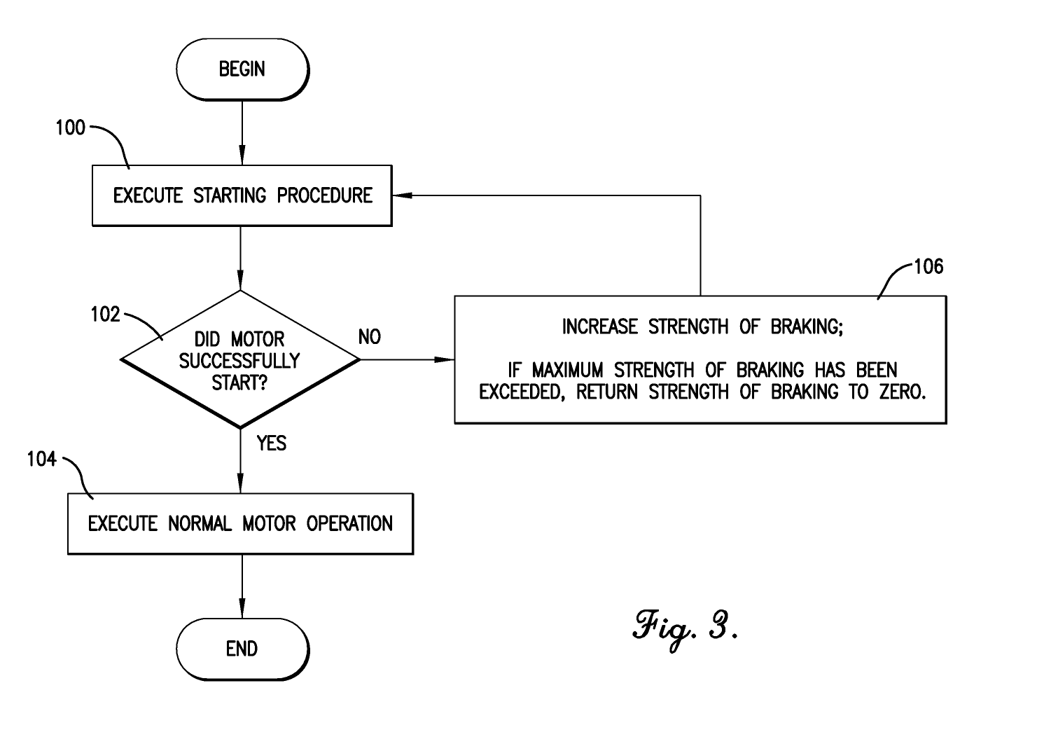

In operation, the system 10 may function as follows. Referring to FIG. 3, in a first implementation of the first embodiment, the motor control system 16 attempts to start the motor by executing the starting procedure, as shown in step 100. In this first attempt, no braking is applied to the motor 12. Next, the motor control system 16 determines whether the motor 12 successfully started, as shown in step 102. If the motor 12 successfully started, then the motor control system 16 proceeds with normal motor operation, as shown in step 104. However, if the motor 12 did not successfully start, then the motor control system 16 applies an initial strength of braking, as shown in step 106, and again attempts to start the motor 12, as shown in step 100. The motor control system 16 again determines whether the motor 12 successfully started, as shown in step 102. If the motor 12 did not successfully start, then the motor control system 16 increases the strength of braking, as shown in step 106, and again attempts to start the motor 12, as shown in step 100. This process is repeated until either the motor 12 successfully starts or a predetermined maximum strength of braking is reached. If the maximum strength of braking is reached, then the strength of braking may be returned to zero and the entire process may be repeated from the beginning.

The initial strength of braking may be approximately between 1% and 3%, or approximately 2%, and each subsequent increase in the strength of braking may be between 1% and 3%, or approximately 2%. The maximum strength of braking may be between 6% and 10%, or approximately 8%. The strength of braking may be controlled by the controller 18, and the strength of braking values, including the maximum strength of braking, may be stored in the memory.

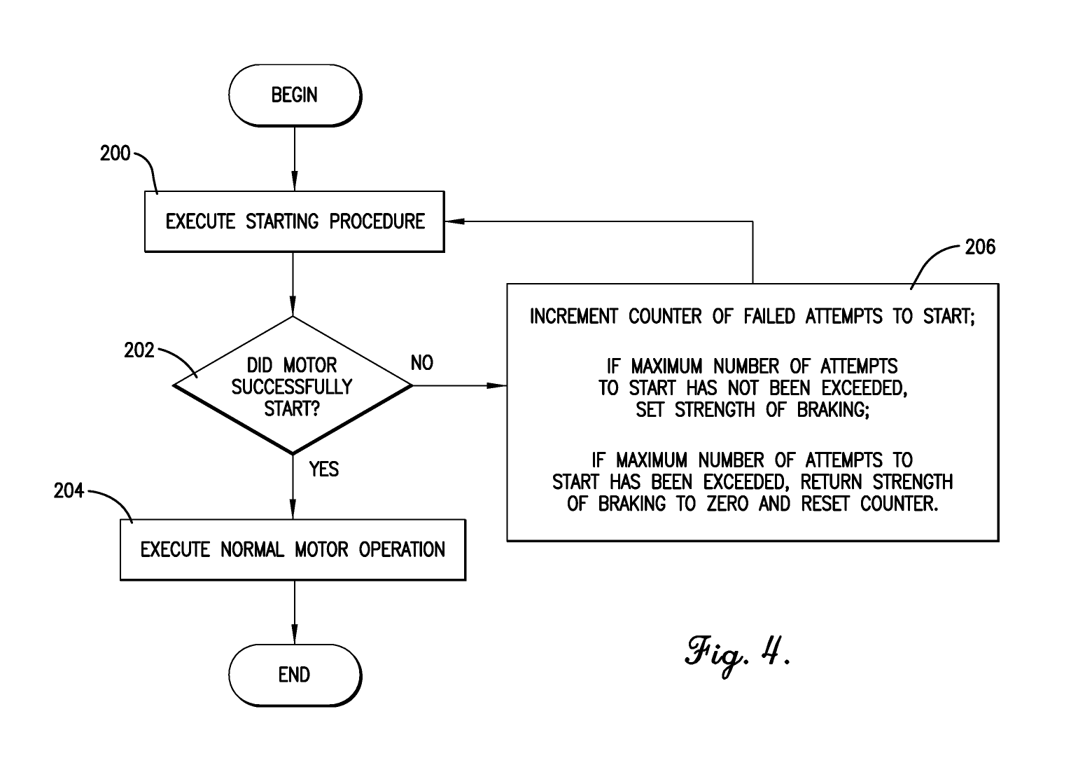

Referring to FIG. 4, in a second implementation of the first embodiment, the motor control system 16 attempts to start the motor by executing the starting procedure, as shown in step 200. In this first attempt, no braking is applied to the motor 12. Next, the motor control system 16 determines whether the motor 12 successfully started, as shown in step 202. If the motor 12 successfully started, then the motor control system 16 proceeds with normal motor operation, as shown in step 204. However, if the motor 12 did not successfully start, then the motor control system 16 may increment a counter and apply an initial strength of braking, as shown in step 206, and attempt again to start the motor 12, as shown in step 200. The motor control system 16 may again determine whether the motor 12 successfully started, as shown in step 202. If the motor 12 did not successfully start, then the motor control system 16 may again increment the counter and increase the strength of braking, as shown in step 206, and attempt again to start the motor 12, as shown in step 200. This process may be repeated until either the motor 12 successfully starts or a predetermined maximum number of attempts to start the motor is reached. If the maximum number of attempts is reached, then the counter may be reset to zero and the strength of braking may be returned to zero, and the entire process may be repeated from the beginning.

The maximum number of attempts to start the motor 12 may be approximately between 8 and 12, or approximately 10. The counter may be implemented on and strength of braking may be controlled by the controller 18, and the amount(s) by which to increase the strength of braking and the predetermined maximum number of attempts may be stored in the memory.

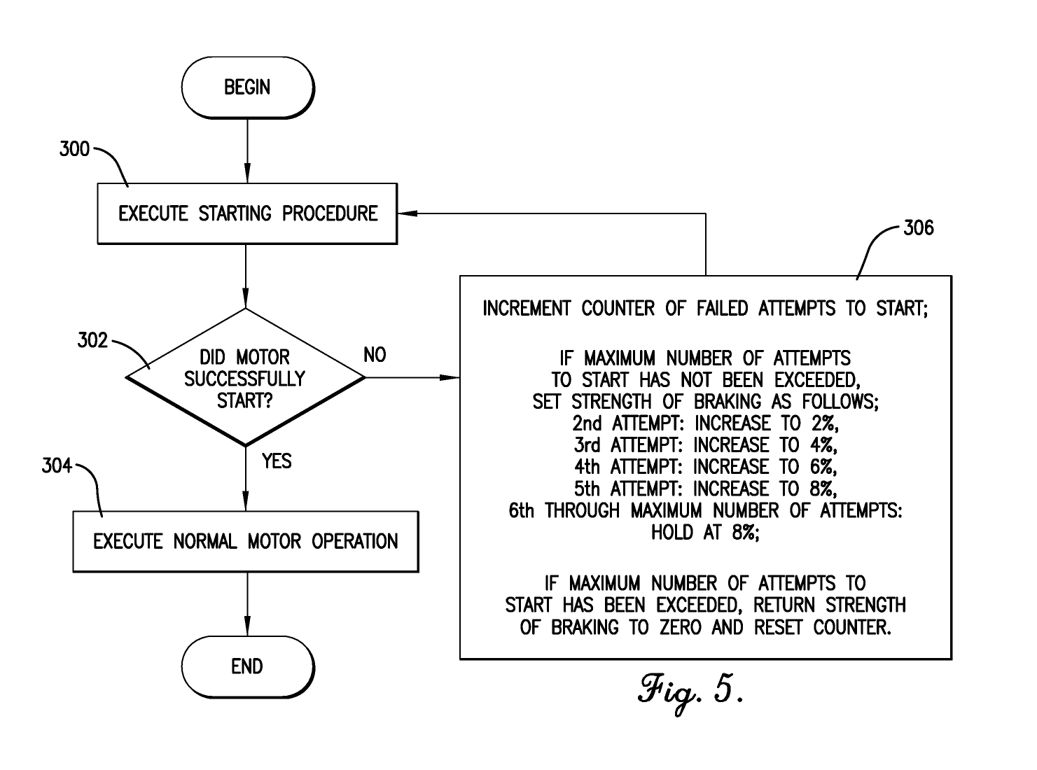

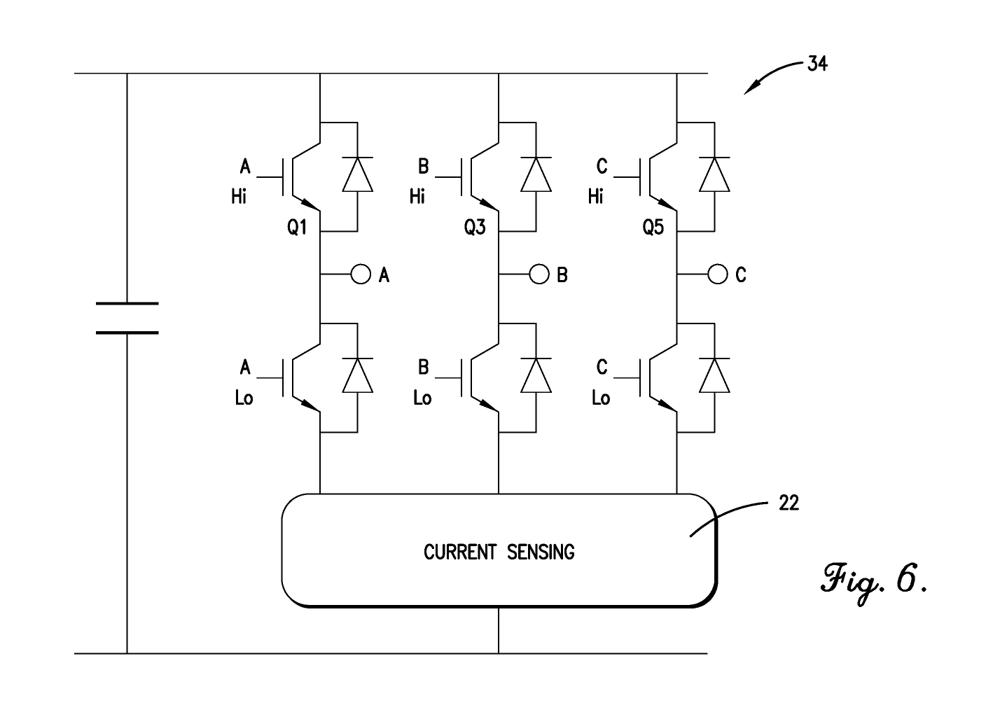

Referring to FIG. 5, in a third implementation of the first embodiment, which is a hybrid of the first and second implementations, the motor control system 16 attempts to start the motor by executing the starting procedure, as shown in step 300. In this first attempt, no braking is applied to the motor 12. Next, the motor control system 16 determines whether the motor 12 successfully started, as shown in step 302. If the motor 12 successfully started, then the motor control system 16 proceeds with normal motor operation, as shown in step 304. However, if the motor 12 did not successfully start, then the motor control system 16 may increment a counter and apply an initial strength of braking, as shown in step 306, and attempt again to start the motor 12, as shown in step 300. The motor control system 16 may again determine whether the motor 12 successfully started, as shown in step 302. If the motor 12 did not successfully start, then the motor control system 16 may again increment the counter and increase the strength of braking, as shown in step 306, and again attempt to start the motor 12, as shown in step 300. This process is repeated until either the motor 12 successfully starts or a predetermined maximum strength of braking is reached. If the maximum strength of braking is reached, then the strength of braking is no longer be increased with each iteration but rather is held constant for the remaining iterations. Thus, once the maximum strength of braking is reached, this process is repeated with the same maximum strength of braking until either the motor 12 successfully starts or a predetermined maximum number of attempts to start the motor 12 is reached. If the maximum number of attempts is reached, then the counter may be reset to zero and the strength of braking may be returned to zero, and the entire process may be repeated from the beginning.

The initial strength of braking may be approximately between 1% and 3%, or approximately 2%, and each subsequent increase in the strength of braking may be between 1% and 3%, or approximately 2%. The maximum strength of braking may be between 6% and 10%, or approximately 8%. The maximum number of attempts to start the motor 12 may be approximately between 8 and 12, or approximately 10. For example, on the second attempt to start the motor 12 approximately 2% strength of braking may be applied to the motor 12, on the third attempt to start the motor 12 approximately 4% strength of braking may be applied, on the fourth attempt to start motor 12 approximately 6% strength of braking may be applied, on the fifth attempt to start the motor the maximum approximately 8% strength of braking may be applied, and on the sixth through the maximum tenth attempts to start the motor 12 the maximum approximately 8% strength of braking may be applied each time, and thereafter the counter and the strength of braking may be reset to zero. The strength of braking may be controlled by the controller 18, the counter may be implemented on the controller 18, and the strength of braking values, including the predetermined maximum strength of braking, and the predetermined maximum number of attempts may be stored in the memory.

In a second embodiment, the system 10 may further include a sensing system 22 operable to sense or otherwise determine whether the rotor 28 is rotating. For example, the sensing system 22 may employ a sensor, such as a Hall effect sensor, or may use an algorithm to determine whether the rotor 28 is rotating based on measured electrical parameters. Referring to FIG. 6, the sensing system 22 may determine whether the rotor 28 is rotating based on current flowing through the power inverter 34.

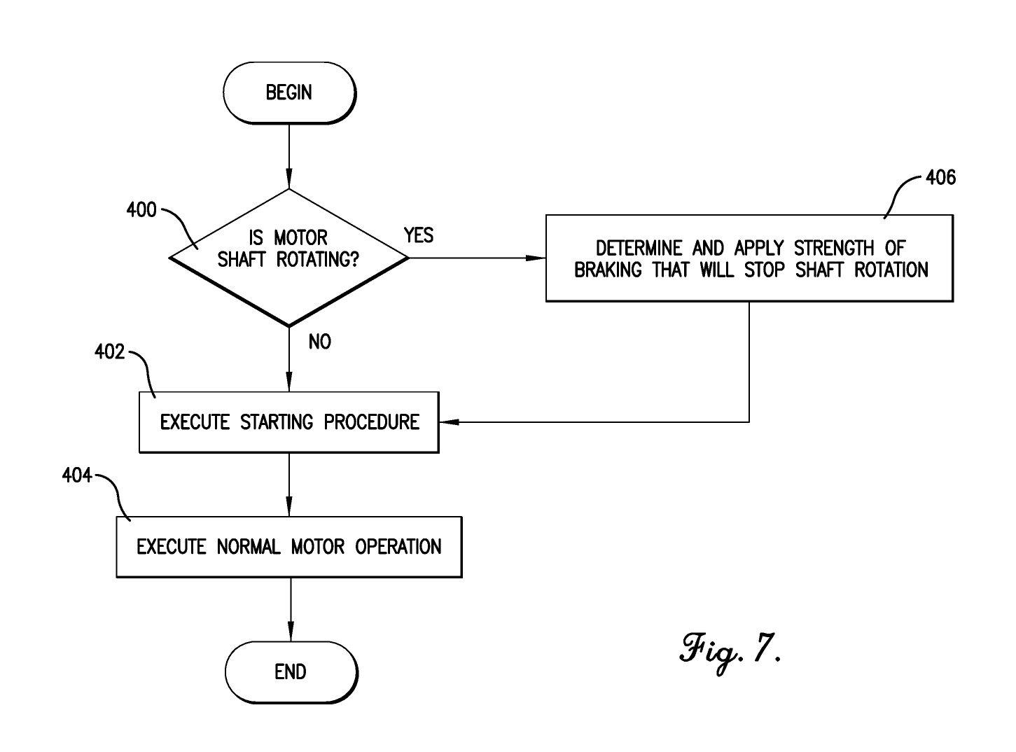

Referring to FIG. 7, in an implementation of the second embodiment, before attempting to start the motor 12, the sensing system 22 determines whether the rotor 28 is rotating, as shown in step 400. If the rotor 28 is not rotating, then the motor control system 16 attempts to start the motor by executing the starting procedure, as shown in step 402, and after the motor starts, the motor control system 16 proceeds with normal motor operation, as shown in step 404. However, if the rotor 28 is rotating, then the controller 18 may determine an appropriate strength of braking to stop the rotation, and apply this appropriate strength of braking via the braking system 20 to stop the rotation, as shown in step 406, and then attempt to start the motor 12 by executing the starting procedure, as shown in step 402. The determination of the appropriate strength of braking may be based on the magnitude of the sensed current, the speed of rotation, and/or the direction of rotation.

The present invention provides advantages over the prior art, including that it can reliably start electric motors without regard to their winding designs and without regard to whether their unenergized rotors are rotating or not. In particular, the present invention provides an improvement to the open loop volts per hertz original starting routine used in, e.g., HAC VS commercial motors.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system comprising:
an electric motor having a rotor;
a controller in communication with the electric motor and operable to control operation of the electric motor; and
a braking system operable to reduce a rotation of the rotor,
wherein—
the controller first attempts to start the electric motor without applying the braking system to the rotor, if the electric motor fails to start,
the controller causes the braking system to apply and then release an initial strength of braking and then again attempts to start the electric motor, and
if the motor still fails to start, the controller iteratively—
automatically causes the braking system to increase the strength of braking applied to the rotor by a predetermined amount which is without regard to a current speed of rotation of the rotor, and
automatically attempts to start the electric motor,
until either the electric motor starts or a predetermined maximum strength of braking is reached.

2. The system as set forth in claim 1, wherein the electric motor is a variable speed electric induction motor or a variable speed permanent magnet motor.

3. The system as set forth in claim 1, wherein the electric motor is coupled with a load, and the load is selected from the group consisting of: a fan, a pump, and an appliance.

4. The system as set forth in claim 1, wherein the braking system employs an opposing driving waveform to reduce the rotation of the rotor.

5. The system as set forth in claim 1, wherein the braking system employs an opposing magnetic field to reduce the rotation of the rotor.

6. The system as set forth in claim 1, wherein the initial strength of braking is approximately between 1% and 3%, and the strength of braking is increased by approximately between 1% and 3% for each iteration.

7. The system as set forth in claim 6, wherein the predetermined maximum strength of braking is approximately between 6% and 10%.

8. A method of starting an electric motor having a rotor and a braking system operable to reduce a rotation of the rotor, wherein the method is automatically implemented by an electronic controller in communication with the electric motor and operable to control operation of the electric motor, the method comprising the steps of:
(1) attempting to start the electric motor without applying the braking system to the rotor;
(2) if the electric motor fails to start, causing the braking system to apply and then release an initial strength of braking to the rotor and then again attempting to start the electric motor; and
(3) if the motor still fails to start, iteratively—
automatically causing the braking system to increase the strength of braking applied to the rotor by a predetermined amount which is without regard to a current speed of rotation of the rotor, and
automatically attempting to start the electric motor,
until either the electric motor starts or a predetermined maximum strength of braking is reached.

9. The method as set forth in claim 8, wherein the electric motor is a variable speed electric induction motor or a variable speed permanent magnet motor.

10. The method as set forth in claim 8, wherein the electric motor is coupled with a load, and the load is selected from the group consisting of: a fan, a pump, an appliance.

11. The method as set forth in claim 8, wherein the braking system employs an opposing driving waveform to reduce the rotation of the rotor.

12. The method as set forth in claim 8, wherein the braking system employs an opposing magnetic field to reduce the rotation of the rotor.

13. The method as set forth in claim 8, wherein the initial strength of braking is approximately between 1% and 3%, and the strength of braking is increased by approximately between 1% and 3% for each iteration of step (3).

14. The method as set forth in claim 13, wherein the predetermined maximum strength of braking is approximately between 6% and 10%.

15. The method as set forth in claim 8, further including the step of (4) if the electric motor fails to start after the predetermined maximum strength of braking is reached, returning to step (1).

16. A system comprising:
an electric motor having a rotor;
a controller in communication with the electric motor and operable to control operation of the electric motor; and
a braking system operable to reduce a rotation of the rotor,
wherein—
the controller first attempts to start the electric motor without applying the braking system to the rotor,
if the electric motor fails to start, the controller causes the braking system to apply and then release an initial strength of braking to the rotor and then again attempts to start the electric motor, and
if the electric motor still fails to start, the controller iteratively—
automatically causes the braking system to increase the strength of braking applied to the rotor by a predetermined amount which is without regard to a current speed of rotation of the rotor, and
automatically attempts to start the electric motor,
until either the electric motor starts or a predetermined maximum number of attempts to start the electric motor is reached.

17. The system as set forth in claim 16, wherein the electric motor is a variable speed electric induction motor or a variable speed permanent magnet motor.

18. The system as set forth in claim 16, wherein the predetermined maximum number of attempts is between 8 and 12.

19. The system as set forth in claim 16, wherein the initial strength of braking is approximately between 1% and 3%, and the strength of braking is increased by approximately between 1% and 3% for each iteration.

20. A method of starting an electric motor having a rotor and a braking system operable to reduce a rotation of the rotor, wherein the method is automatically implemented by an electronic controller in communication with the electric motor and operable to control operation of the electric motor, the method comprising the steps of:
(1) attempting to start the motor without applying the braking system to the rotor;
(2) if the electric motor fails to start, causing the braking system to apply and then release an initial strength of braking to the rotor and then again attempting to start the electric motor; and
(3) if the electric motor still fails to start, iteratively—
automatically causing the braking system to increase the strength of braking applied to the rotor by a predetermined amount which is without regard to a current speed of rotation of the rotor, and
automatically attempting to start the electric motor,
until either the electric motor starts or a predetermined maximum number of attempts to start the electric motor is reached.

21. The method as set forth in claim 20, wherein the electric motor is a variable speed electric induction motor or a variable speed permanent magnet motor.

22. The method as set forth in claim 20, wherein the predetermined maximum number of attempts is between 8 and 12.

23. The method as set forth in claim 20, further including the step of (4) if the electric motor fails to start after the predetermined maximum number of attempts to start the electric motor is reached, returning to step (1).

24. A system comprising:
an electric motor having a rotor;
a controller in communication with the electric motor and operable to control operation of the electric motor; and
a braking system operable to reduce a rotation of the rotor,
wherein—
the controller first attempts to start the electric motor without applying the braking system to the rotor,
if the electric motor fails to start, the controller causes the braking system to apply and then release an initial strength of braking to the rotor and then again attempts to start the electric motor,
if the motor still fails to start, the controller iteratively—
automatically causes the braking system to increase the strength of braking applied to the rotor by a predetermined amount which is without regard to a current speed of rotation of the rotor, and
automatically attempts to start the electric motor,
until either the electric motor starts or a predetermined maximum strength of braking is reached, and
if the motor still fails to start, the controller iteratively—
automatically causes the braking system to apply the predetermined maximum strength of braking applied to the rotor, and
automatically attempts to start the electric motor,
until either the electric motor starts or a predetermined maximum number of attempts to start the electric motor is reached.

25. The system as set forth in claim 24, wherein the electric motor is a variable speed electric induction motor or a variable speed permanent magnet motor.

26. The system as set forth in claim 24, wherein the initial strength of braking is approximately between 1% and 3%, and the strength of braking is increased by approximately between 1% and 3% for each iteration.

27. The system as set forth in claim 26, wherein the predetermined maximum strength of braking is approximately between 6% and 10%.

28. The system as set forth in claim 24, wherein the predetermined maximum number of attempts is between 8 and 12.

29. A method of starting an electric motor having a rotor and a braking system operable to reduce a rotation of the rotor, wherein the method is automatically implemented by an electronic controller in communication with the electric motor and operable to control operation of the electric motor, the method comprising the steps of:
(1) attempting to start the electric motor without applying the braking system to the rotor;
(2) if the electric motor fails to start, substantially automatically causing the braking system to apply and then release an initial strength of braking to the rotor and again attempting to start the motor;
(3) if the electric motor still fails to start, iteratively—
automatically causing the braking system to increase the strength of braking applied to the rotor by a predetermined amount which is without regard to a current speed of rotation of the rotor, and
automatically attempting to start the electric motor,
until either the electric motor starts or a predetermined maximum strength of braking is reached; and
(4) if the electric motor still fails to start, iteratively—
automatically causing the braking system to apply the braking system at the predetermined maximum strength of braking, and
automatically attempting to start the electric motor,
until either the electric motor starts or a predetermined maximum number of attempts to start the electric motor is reached.

30. The method as set forth in claim 29, wherein the electric motor is a variable speed electric induction motor or a variable speed permanent magnet motor.

31. The method as set forth in claim 29, wherein the initial strength of braking is approximately between 1% and 3%, and the strength of braking is increased by approximately between 1% and 3% for each iteration of step (3).

32. The method as set forth in claim 31, wherein the predetermined maximum strength of braking is approximately between 6% and 10%.

33. The method as set forth in claim 29, wherein the predetermined maximum number of attempts is between 8 and 12.

34. The method as set forth in claim 29, further including the step of (5) if the motor fails to start after the predetermined maximum number of attempts to start the motor is reached, returning to step (1).
